(19) United States
(12) Patent Application Publication
(10) Pub. No.: US 2018/0189290 A1
(43) Pub. Date: Jul. 5, 2018

(54) CONTENT OBJECT INDEXING AND RESOLUTION SYSTEM

(71) Applicant: Microsoft Technology Licensing, LLC, Redmond, WA (US)

(72) Inventors: Nishan Naseer, Bangalore KA (IN); Saket Saurabh, Dumka JH (IN)

(21) Appl. No.: 15/494,703

(22) Filed: Apr. 24, 2017

(30) Foreign Application Priority Data
Dec. 30, 2016 (IN) 201641045115

(51) Int. Cl. G06F 17/30

(52) U.S. Cl. CPC G06F 17/3053; G06F 17/30864; G06F 17/30554

(57) ABSTRACT

A data model is applied to parse content objects and they are stored in a service data store that stores indications of parsed content objects. Each content object corresponds to an application state and has attributes. Precedence resolution logic that resolves between multiple content objects corresponding to the same application state, based on the attributes.

### CROSS-REFERENCE TO RELATED APPLICATION

The present application is based on and claims the benefit of Indian provisional patent application Serial No. 201641045115, filed Dec. 30, 2016, the content of which is hereby incorporated by reference in its entirety.

### BACKGROUND

Computer systems are currently in wide use. Some computer systems host applications while others provide services for applications run on a client or on a client component of a hosted service.

Applications display content objects in response to interactions with users. Typically, in response to a user interaction that specifies an application state (such as navigating to a page in an application), a content object is loaded in response to a service call to an application host. The content object corresponds to the application state. Also, data for a given display may come from multiple different locations. For instance, when a user is using an application that displays contacts on one display (e.g., in one application state) and company products on another display (e.g., in another application state), the user may switch from one display to the other. The data to populate the display may come from multiple different locations, thus requiring multiple different service calls. For any given application sate, there may be more than one content object that can be displayed based on a variety of different criteria.

The discussion above is merely provided for general background information and is not intended to be used as an aid in determining the scope of the claimed subject matter.

### SUMMARY

A data model is applied to parse content objects and they are stored in a service data store that stores indications of parsed content objects. Each content object corresponds to an application state and has attributes. Precedence resolution logic resolves between multiple content objects corresponding to the same application state, based on the attributes.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one example of a computing system architecture.

FIG. 2 is a block diagram showing one example of a content object delivery system deployed in a cloud computing environment, in more detail.

FIG. 3 shows a flow diagram of one example operation of parsing, indexing and storing content objects for storage in a client store.

FIG. 4 shows a flow diagram of one example operation of selecting a content object, from a set of possible content objects, for storage in a client store.

FIG. 5 shows a flow diagram of one example of applying a precedence hierarchy to resolve between two content objects corresponding to a same application state.

FIG. 6 shows a flow diagram for displaying a content object in an application.

FIG. 7 shows the architecture of FIG. 1 deployed in a cloud computing system.

FIG. 8 is a block diagram showing a mobile device that can be used in the architectures shown in previous Figures.

FIGS. 9-10 show examples of mobile devices.

FIG. 11 shows one example of a computing environment that can be used in the architectures shown in previous Figures.

### DETAILED DESCRIPTION

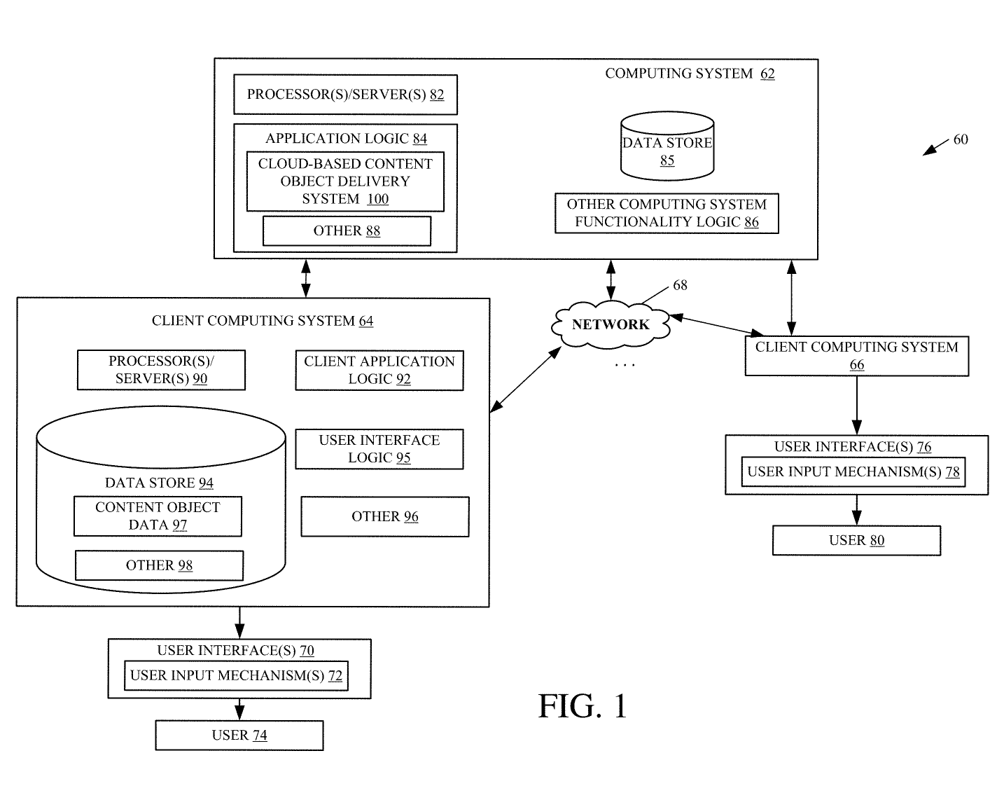

FIG. 1 is a block diagram of one example of a computing system architecture 60. Architecture 60 shows computing system 62 coupled to client computing systems 64-66 either directly, or over network 68. Network 68 can be any of a wide variety of networks, such as a wide area network, a local area network, a near field communication network, a cellular network or any of a wide variety of other networks or combinations of networks.

FIG. 1 also shows that client computing system 64 generates a set of user interfaces 70 with user input mechanisms 72 for interaction by user 74. User 74 illustratively interacts with user input mechanisms 72 to control and manipulate client computing system 64 and some portions of computing system 62. Similarly, FIG. 1 also shows that client computing system 66 generates a set of user interfaces 76 with user input mechanisms 78 for interaction by user 80. User 80 illustratively interacts with user input mechanisms 78 to control and manipulate client computing system 66 and some portions of computing system 62.

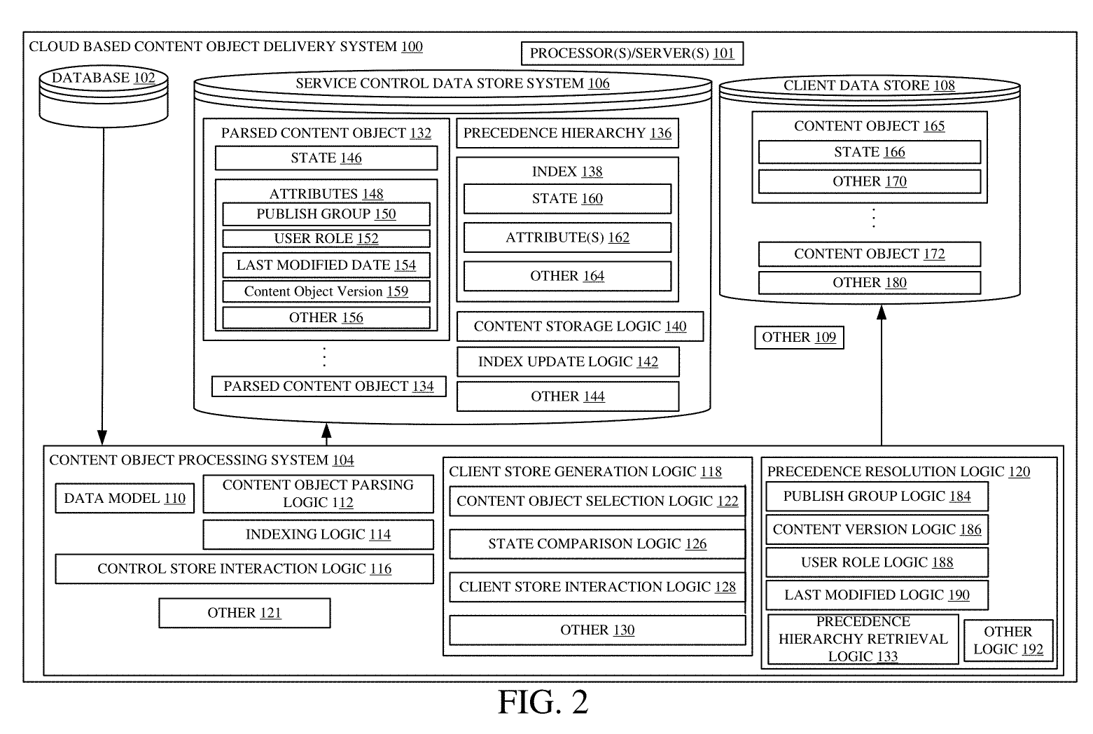

In the example shown in FIG. 1, computing system 62 illustratively includes processors or servers 82, application logic 84, data store 85, and other computing system functionality logic 86. Application logic 84, itself, can include cloud-based content object delivery system 100 and a variety of other items 88. Application logic 84 illustratively exposes interfaces that can be used to perform functionality for client computing systems 64 and 66 in running applications. This can be front end and backend hosting services, among a wide variety of other services. In one example, cloud-based content object delivery system 100 generates content objects that are made available to client computing systems 64 and 66. Each content object can include a set of data or data records, controls, display elements, attributes and other items that are surfaced by an application when the application is in an application state that corresponds to the content object. System 100 illustratively chooses a content object, from a variety of available content objects, based on a set of criteria, so that the content object is chosen appropriately for the particular client system that will be accessing it. System 100, and its operation, are described in greater detail below with respect to FIGS. 2-7.

It will be noted that client computing systems 64 and 66 can be similar or different. For purposes of the present description, it will be assumed that they are similar, so that only client computing system 64 is described in more detail. In the example illustrated, client computing system 64 includes one or more processors or servers 90, client application logic 92, data store 94, user interface logic 95, and it can include a wide variety of other items 96. Data store 94, itself, illustratively includes content object data 97 and it can also include a wide variety of other items 98. Client application logic 92 illustratively runs one or more applications, or it acts as a client component of an application hosted by computing system 62. It illustratively performs application functionality and, in doing so, interacts with and operates on content object data 97. Logic 92 also illustratively uses user interface logic 95 to surface content object data 97 for viewing and interaction by user 74. It can detect user interaction with the user input mechanisms 72 and perform operations based on those interactions, or it can provide information, indicative of those interactions, to other items in architecture 100.

The content object data 97 can include a plurality of different content objects that can be processed to generate user interfaces 70. The particular content object used illustratively depends on a variety of criteria, such as the state of the application (e.g., whether user 74 is viewing a Contacts page or a Products page or a Leads page in the application), the role or identity of user 74, etc. The particular content object may be one of a plurality of different content objects that correspond to the same application state, and the data on the content object may come from a plurality of different sources. Therefore, in accordance with one example, cloud-based content object delivery system 100 resolves conflicts among the various content objects that may be downloaded during the initiation or initialization of the application or during runtime, and makes the chosen content object, for each state of the application, available in a data store, for download to the client computing system 64. This is now described in more detail.

FIG. 2 is a block diagram of one example of content object delivery system 100 in more detail. System 100 illustratively includes one or more processors or servers 101 (or they can be processors or servers 82 shown in FIG. 1), a service database 102, content object processing system 104, service control data store system 106, client data store 108 and it can have other items 109 as well. Content object processing system 104 can have data model 110, content object parsing logic 112, indexing logic 114, control store interaction logic 116, client store generation logic 118, precedence resolution logic 120 and it can have other items 121. Client store generation logic 118, itself, can include content object selection logic 122, state comparison logic 126, client store interaction logic 128 and it can include other items 130. Precedence resolution logic 120 can, itself, include precedence hierarchy retrieval logic 133, publish group logic 184, content version logic 186, user role logic 188, last modified logic 190, and it can include other items 192.

Before describing system 100 in more detail, a brief overview of some of the items in system 100, and their operation, will first be provided. Service database 102 includes service data for a hosted service. Database 102 may include multiple different data objects that could possibly be displayed to a user, during runtime, for any given application state. The application states can be defined by the application developer or otherwise.

Therefore, content object processing system 104 obtains the content objects for the application and parses and indexes them using data model 110, parsing logic 112 and indexing logic 114. The content objects can be parsed to identify values for certain attributes (which can be used, as described later, to identify highest precedence content objects) and to identify the application state that the content object corresponds to. Control store interaction logic 116 stores the parsed and indexed content objects in control store system 106. Thus, control data store system 106 illustratively stores parsed content objects 132-134, a precedence hierarchy 136, index 138, content storage logic 140 and index update logic 142, and it can include other items 144. Each of the parsed content objects 132-134 can include a state identifier 146 that identifies the application state the content object corresponds to, and a set of attributes 148 that can be used in applying the precedence hierarchy 136 (as is described below). The attributes shown in the example in FIG. 2 include publish group 150, user role 152, last modified date 154, content object version 159 and they can include other attributes 156.

Index 138 can index the parsed content objects 132-134 by state 160, attributes 162 and other items 164. Content storage logic 140 can be used to store, search and retrieve the parsed content objects 132-134, and index update logic 142 can be used to update index 138.

To reduce the number of service calls that a client system makes to the hosted service, in order to obtain data from service database 102, client store generation system 128 obtains the parsed content objects 132-134 from control store system 106 and identifies the content objects that correspond to the application states for the particular client being considered, and stores those content objects in client data store 108 (which can be in the cloud, on the client system, or elsewhere). When two or more parsed content objects correspond to the same application state, then client store generation system 118 uses precedence resolution logic 120 to identify a highest precedence content object for the application state and stores that content object in client store 108. In doing so, precedence hierarchy retrieval logic 133 obtains precedence hierarchy 136 and applies the precedence hierarchy 136 with publish group logic 184, content version logic 186, user role logic 188, last modified logic 190 and other logic 192. Client data store 108 thus stores a plurality of content objects 165-172, each of which corresponds to an application state 166 and has other attributes 170, and can store other items 180 as well.

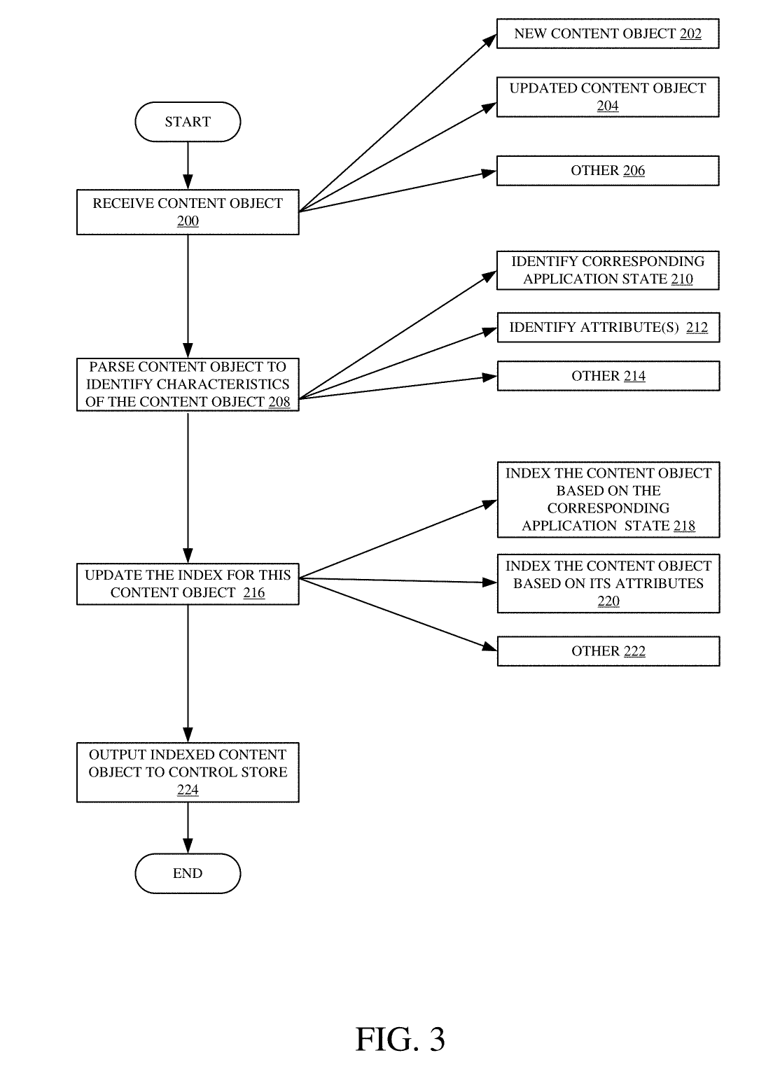

FIG. 3 is a flow diagram illustrating the operation of system 100 in parsing and indexing content objects from service database 102. Content object parsing logic 112 first receives a content object from database 102. This is indicated by block 200. It can be a new content object 202, an updated one 204 or another content object 206.

Parsing logic 112 then applies data model 110 to parse the content object to identify certain characteristics of the content object (such as values for certain attributes or properties of the content object). This is indicated by block 208. For instance, it can identify a corresponding application state 210 for the content object. It can identify the attributes 148, as indicated by block 212 in the flow diagram of FIG. 3. It can parse the content object to identify other items as well, and this is indicated by block 214.

Indexing logic 114 then calls index update logic 142 to update index 138 for this content object. This is indicated by block 216. For instance, it can update index 138 to index the content object by state, by attributes, etc. This is indicated by blocks 218, 220 and 222 in FIG. 3.

Control store interaction logic 116 then interacts with content storage logic 140 to store the indexed content object on control store system 106 as a parsed content object. This is indicated by block 224 in FIG. 3.

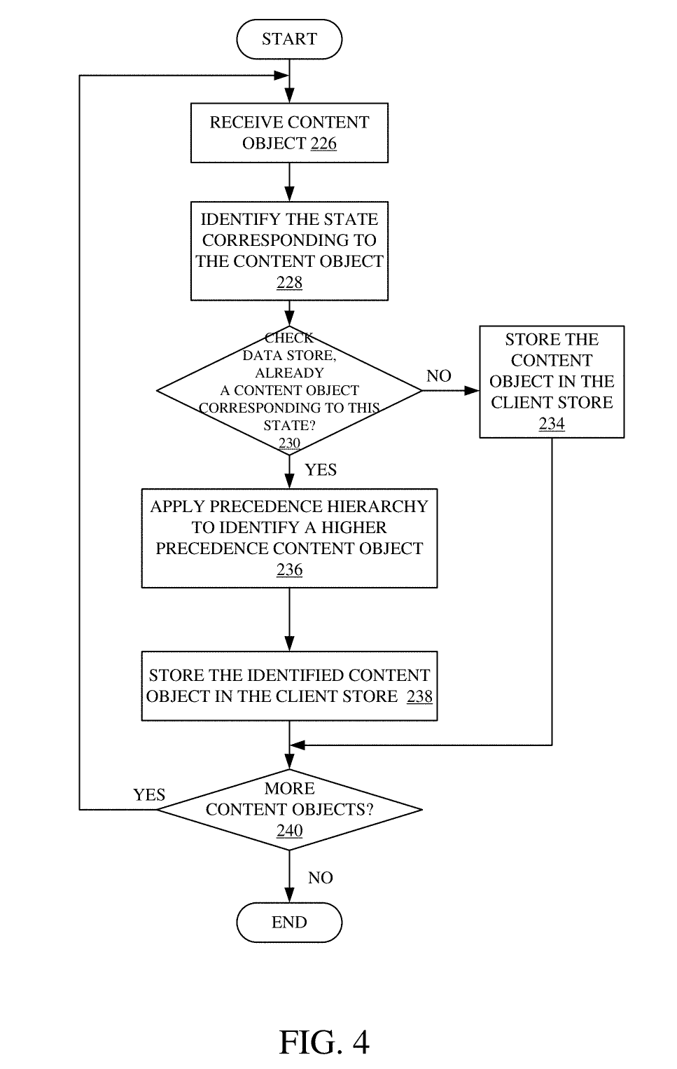

FIG. 4 is a flow diagram illustrating how client store generation logic 118 generates client store 108 from the parsed content objects in control store system 106. Content object selection logic 122 first receives a content object from control store system 106. This is indicated by block 226. It identifies the application state corresponding to the content object, as indicated by block 228. State comparison logic 126 then determines whether the client store 108 already has a content object corresponding to that application state. This is indicated by block 230. If not, client store interaction logic 128 stores the content object on the client data store 108. This is indicated by block 234 in the flow diagram of FIG. 4.

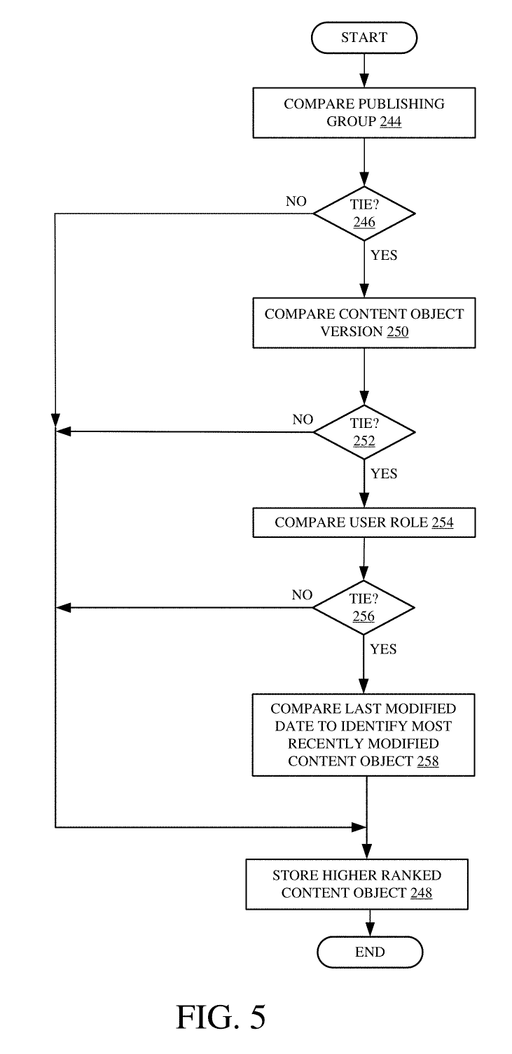

If, at block 230, it is determined that client data store 108 already has a content object corresponding to the identified state, then precedence resolution logic 120 applies precedence hierarchy 136 to the two conflicting content objects (those that correspond to the same application state) to identify a higher precedence content object. This is indicated by block 236 in FIG. 4 and is described in greater detail below with respect to FIG. 5. Client store interaction logic 128 then stores the higher ranking content object in the client store 108. This is indicated by block 238. This process continues until the content objects in control store system 106 have been processed. This is indicated by block 240.

FIG. 5 is a flow diagram illustrating one example of how precedence resolution logic 120 identifies a higher precedence content object, of two conflicting content objects. In FIG. 5, it is assumed that the precedence hierarchy 136 identifies the attributes in rank order so if one of the content objects has an attribute value that is better than the other content object for a higher ranking attribute, then that content object (the one with the better attribute value) is determined to be higher ranking than the other content object. In the example shown in FIG. 5, it is assumed that the attributes, in rank order, are publishing group, content object version, user role and last modified date. Therefore, the corresponding items of logic in precedence resolution logic 120 compare the attributes of the two content objects until one of them wins and is determined to be of higher precedence.

Publish group logic 184 first compares the values of the publish group attributes of the two content objects. This is indicated by block 244. If one is better, that is the higher precedence content object and is stored in the client store 108. This is indicated by blocks 246 and 248 in FIG. 5. If the publishing group attribute is the same on both content objects, then the content version logic 186 compares values for the content version attributes and chooses the one with the better value for storage in client data store 108. This is indicated by blocks 250 and 252. If those two values are the same, then the user role logic compares the user role values on the two content objects and chooses the content object with the better role value. This is indicated by blocks 254 and 256. Ultimately, last modified logic 190 compares the last modified date values of the two content objects to break any remaining tie. This is indicated by block 258.

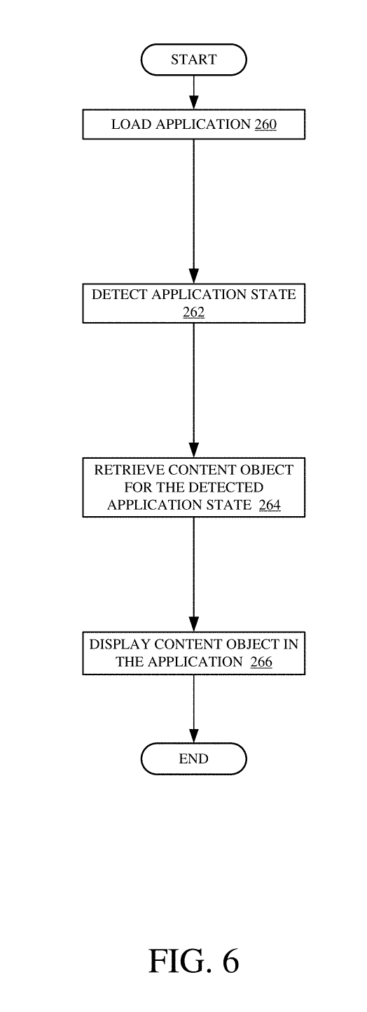

FIG. 6 is a flow diagram illustrating how an application can obtain content objects from client data store 108 during initialization (or runtime). After the application is loaded at block 260, the application state is detected. This is indicated by block 262. The content object for that application state is then retrieved from client store 108. This is indicated by block 264. Recall that there is now only a single content object in client store 108 for each application state. Therefore, there need not be any additional round trips to the client store 108 or the service database 102. The retrieved content object for the application state is then displayed or otherwise surfaced on the client system for the user. This is indicated by block 266. When the application state changes, then this process repeats and the content object corresponding to the new application state is obtained and surfaced. Again, client store 108 will only have a single content object for the new application state as well.

For purposes of explanation only, and not by limitation, some examples are presented below to illustrate the parsing and indexing operations completed by system 100. This example is presented only as one example of the function and operation of system 100, and is not intended to limit the scope of the discussion.

A content object can be in an application which can have corresponding, predefined attributes (or parameters), which can have attribute values, and predefined precedence values associated with the attribute values or corresponding to them. For example, Table 1 presents an example publish group precedence table that shows a precedence value for each of a plurality of different values for the publish group attribute of a content object.

TABLE 1
Publish Group Precedence Values

| publish group id | publish group precedence value |
|---|---|
| “PG1” | 1 |
| “PG2” | 2 |
| “PG3” | 3 |

For example, in a conflict, publish group “PG3” is selected over either “PG2” or “PG1,” as “PG3” has the highest precedence. Additionally, preassigned user role precedence values can also be stored in a precedence table for a user role attribute. Table 2 shows one example of this.

TABLE 2
User Role Precedence Values

| user role id | user role precedence value |
|---|---|
| “account manager” | 3 |
| “sales manager” | 2 |
| “marketing manager” | 1 |
| “system administrator” | 5 |
| “contact manager” | 4 |

A set of precedence hierarchy processing examples will now be described. They are examples only. In example 1 that follows, a precedence order ranking list (or precedence hierarchy) used by precedence resolution logic 120 lists attributes in precedential order, and comprises: (1) publish group, (2) content object version, (3) user role, (4) last modified date, such that a conflict is first solved by reviewing Table 1, then by checking versions of each conflicting content object, then by reviewing Table 2, then by the last modified date of the content object.

### Example 1: Resolving the Content Object Data for Application State “Account” Using Content Object Resolution Algorithm

### Mock ContentObject Data=

### [{Id: 1,

state: “crm.microsoft.com/account”,
htmlContent object: “<htm1><div id=“accountpage”>HtmlContent object_1</div></html>”,
publishgroupInfo:{id: “PG1”}
content objectversion: “v1.0”,
userroleInfo: {{id: “account manager”}, {id: “system administrator”}},
lastmodifieddate: “2016-12-15T13:43:42.248Z”},

### {Id: 2,

state: “crm.microsoft.com/account”,
htmlContent object: “<htm1><div id=“accountpage”>HtmlContent object_2</div></html>”,
publishgroupInfo:{id: “PG2”}
content objectversion: “v1.0”,
userroleInfo: {{id: “account manager”}, {id: “system administrator”}},
lastmodifieddate: “2016-12-19T13:43:42.248Z”},

### {Id: 3,

state: “crm.microsoft.com/account”,
htmlContent object: “<htm1><div id=“accountpage”>HtmlContent object_3</div></html>”,
publishgroupInfo: {id: “PG1”}
content objectversion: “v1.0”,
userroleInfo: {{id: “account manager”}, {id: “system administrator”}},
lastmodifieddate: “2016-12-17T13:43:42.248Z”},]

In this example, for the application state “account”, there are three Content objectData candidates representing (or corresponding to the) same state. These are compared based on attributes 148, starting from the highest precedence value attribute to the lowest precedence value attribute listed in a precedence ranking order (or precedence hierarchy) used by precedence resolution logic 120.

The set of Content objectData candidates for application state “account” is {Content objectData Id: 1, Content objectData Id: 2, Content objectData Id: 3}.

First, the publishgroupInfo attribute of the Content objectData's are compared. In order to decide which Content objectData publishgroupInfo has higher precedence, a publishgroupPrecedenceList Map is retrieved from data storage, for example Table 1. If the publishgroupInfo attribute of one Content objectData is having higher precedence compared to the other, then the Content objectData with higher precedence, becomes the winner candidate. Content objectData with Id 1 and Id 3 belongs to publishgroup “PG1” and Content objectData with Id 2 belongs to publishgroup “PG2”. From the publishgroupPrecedenceList Map of the Content objectStore, we find that publishgroup “PG2” is having higher precedence as compared to publishgroup “PG1”. So the winner candidate is Content objectData with Id 2.

### Example 2: Resolving the Content Object Data for Application State “Marketing” Using Content Object Resolution Algorithm

### Mock ContentObject Data=

### {Id: 1,

state: “crm.microsoft.com/marketing”,
htmlContent object:“<html><div id=“marketingpage”>HtmlContent object_1</div></html>”,
publishgroupInfo: {id: “PG1”}
content objectversion: “v1.0”,
userroleInfo: {{id: “marketing manager”}, {id: “system administrator”}},
lastmodifieddate: “2016-12-15T13:43:42.248Z”},

### {Id: 2,

state: “crm.microsoft.com/marketing”,
htmlContent object: “<html><div id=“marketingpage”>HtmlContent object_2</div></html>”,
publishgroupInfo:{id: “PG2”} content objectversion: “v1.0”,
userroleInfo: {{id: “marketing manager”}, {id: “system administrator”}},
lastmodifieddate: “2016-12-16T13:43:42.248Z”},

### {Id: 3,

state: “crm.microsoft.com/marketing”,
htmlContent object: “<html><div id=“marketingpage”>HtmlContent object_3</div></html>”, publishgroupInfo:{id: “PG2”}
content objectversion: “v2.0”,
userroleInfo: {{id: “marketing manager”}, {id: “system administrator”}},
lastmodifieddate: “2016-12-18T13:43:42.248Z”},]

In this example, for the application state “marketing”, there are three Content objectData candidates representing the same state. These are compared based on their attribute value starting from the highest precedence attribute to the lowest precedence attribute listed in the precedence order ranking list (or precedence hierarchy) of the “Content object Resolution” Algorithm implemented by logic 120.

The set of Content objectData candidates for application state “marketing” is {Content objectData Id: 1, Content objectData Id: 2, Content objectData Id: 3}. First, publishgroup Precedence is applied. Content objectData with Id 1 belongs to publishgroup “PG1” and Content objectData with Id 2 and Id 3 belongs to publishgroup “PG2”. From the publishgroupPrecedenceList Map presented in Table 1, we find that publishgroup “PG2” has higher precedence than publishgroup “PG1”. So Content objectData with Id 1 is dropped. Content objectData with Id 2 and Id 3 belongs to same publishgroup “PG2” and so we have a Tie for Content objectData with Id 2 and Id 3, and an additional precedence value needs to be compared.

Set of Content objectData candidates for application state “marketing” after Applying publishgroup Precedence={Content objectData Id: 2, Content objectData Id: 3}. Next, content objectversion Precedence is applied. The content objectversion of Content objectData with Id 3 is higher than the content objectversion of Content objectData with Id 2. So the winner candidate is Content objectData with Id 3.

### Example 3: Resolving the Content Object Data for Application State “Sales” Using Content Object Resolution Algorithm

### Mock ContentObject Data=[{Id 1,

state: “crm.microsoft.com/sales”,
htmlContent object: “<html><div id=“salespage”>HtmlContent object_1</div></html>”,
publishgroupInfo: {id: “PG1”}
content objectversion: “v1.0”,
userroleInfo: {{id: “sales manager”}},
lastmodifieddate: “2016-12-15T13:43:42.248Z”},

### {Id: 2,

state: “crm.microsoft.com/sales”,
htmlContent object: “<html><div id=“salespage”>HtmlContent object_2</div></html>”,
publishgroupIfo:{id: “PG2”}
content objectversion: “v1.0”,
userroleInfo: {{id: “sales manager”}},
lastmodifieddate: “2016-12-16T13:43:42.248Z”},

### {Id: 3,

state: “crm.microsoft.com/sales”,
htmlContent object: “<html><div id=“salespage”>HtmlContent object_3</div></html>”,
publishgroupInfo:{id: “PG2”}
content objectversion: “v2.0”,
userroleInfo: {{id: “system administrator”}},
lastmodifieddate: “2016-12-18T13:43:42.248Z”},

### {Id: 4,

state: “crm.microsoft.com/sales”,
htmlContent object: “<htm1><div id=“salespage”>HtmlContent object_4</div></html>”,
publishgroupInfo:{id: “PG2”}
content objectversion: “v2.0”,
userroleInfo: {{id:“sales manager”}},
lastmodifieddate: “2016-12-24T13:43:42.248Z”},]

In this example, for the application state “marketing,” there are four Content objectData candidates representing the same state. The candidates are compared based on attribute values starting from the highest precedence attribute to the lowest precedence attribute listed in the precedence hierarchy (or proceedings order ranking list) of the content object resolution system.

The set of Content objectData candidates for application state “sales” is {Content objectData Id: 1, Content objectData Id: 2, Content objectData Id: 3, Content objectData Id: 4}

First publishgroup Precedence is applied. Content objectData with Id 1 belongs to publishgroup “PG1” and Content objectData with Id 2, Id 3 and Id 4 belongs to publishgroup “PG2.” Based on the publishgroupPrecedenceList Map stored in the Content objectStore and presented as Table 1, publishgroup “PG2” has higher precedence than publishgroup “PG1”. So Content objectData with Id 1 is dropped. Content objectData with Id 2, Id 3 and Id 4 belongs to same publishgroup “PG2” and so we have a Tie for Content objectData with Id 2, Id 3 and Id 4.

The set of Content objectData candidates for application state “sales” after Applying publishgroup Precedence is {Content objectData Id: 2, Content objectData Id: 3, Content objectData Id: 4}

Then, content objectversion Precedence is compared for the remaining candidates. The content objectversion of Content objectData with Id 3 and Id 4 is higher than the content objectversion of Content objectData with Id 2. So Content objectData with Id 2 is dropped. Content objectData with Id 3 and Id 4 have same content objectversion “v2.0” and so we have a Tie for Content objectData with Id 3 and Id 4.

The set of Content objectData candidates for application state “sales” after Applying content objectversion Precedence={Content objectData Id: 3, Content objectData Id: 4}.

Then, userrole Precedence is compared for the remaining candidates. From the userrolePrecedenceList Map of the Content objectStore, illustrated as Table 2, the userrole “system administrator” of Content object Data with Id 3 is having higher precedence compared to the userrole “sales manager” of Content object Data with Id 4. So Content objectData with Id 4 is dropped and the winner candidate is Content objectData with Id 3.

### Example 4: Resolving the Content Object Data for Application State “Contact” Using Content Object Resolution Algorithm

### Mock ContentObject Data=[

### {Id: 1,

state: “crm.microsoft.com/contact”,
htmlContent object: “<htm1><div id=“contactpage”>HtmlContent object_1</div></html>”,
publishgroupInfo: {id: “PG1”}
content objectversion: “v1.0”,
userroleInfo: {{id: “contact manager”}},
lastmodifieddate: “2016-12-15T13:43:42.248Z”},

### {Id: 2,

state: “crm.microsoft.com/contact”,
htmlContent object: “<html><div id=” contactpage“>HtmlContent object_2</div></html>”,
publishgroupInfo:{id: “PG2”}
content objectversion: “v1.0”,
userroleInfo: {{id: “contact”}},
lastmodifieddate: “2016-12-16T13:43:42.248Z”},

### {Id: 3,

state: “crm.microsoft.com/contact”,
htmlContent object: “<html><div id=“contactpage”>HtmlContent object_3</div></html>”,
publishgroupInfo:{id: “PG2”}
content objectversion: “v2.0”,
userroleInfo:{{id: “system administrator”}},
lastmodifieddate: “2016-12-18T13:43:42.248Z”},

### {Id: 4,

state: “crm.microsoft.com/contact”,
htmlContent object: “<html><div id=“contactpage”>HtmlContent object_4</div></html>”,
publishgroupInfo:{id: “PG2”}
content objectversion: “v2.0”,
userroleInfo: {{id: “system administrator”}},
lastmodifieddate: “2016-12-24T13:43:42.248Z”},

### {Id: 5,

state: “crm.microsoft.com/contact”,
htmlContent object: “<html><div id=“contactpage”>HtmlContent object_5</div></html>”,
publishgroupInfo: {id: “PG2”}
content objectversion: “v2.0”,
userroleInfo: {{id: “contact manager”}},
lastmodifieddate: “2016-12-14T13:43:42.248Z”},]

In this example, for the application state “marketing”, there are five Content objectData candidates representing same state. These are compared based on attribute values starting from the highest precedence attribute to the lowest precedence attribute listed in the precedence hierarchy (or procedure order ranking list) used by the Content object Resolution System.

The Set of Content objectData candidates for application state “contact” is {Content objectData Id: 1, Content objectData Id: 2, Content objectData Id: 3, Content objectData Id: 4, Content objectData Id: 5}

First, publishgroup Precedence is applied. Content objectData with Id 1 belongs to publishgroup “PG1” and Content objectData with Id 2, Id 3, Id 4 and Id 5 belongs to publishgroup “PG2”. From the publishgroupPrecedenceList Map of the Content objectStore, illustrated as Table 1, we find that publishgroup “PG2” is having higher precedence as compared to publishgroup “PG1”. So Content objectData with Id 1 is dropped. Content objectData with Id 2, Id 3, Id 4 and Id 5 belongs to same publishgroup “PG2” and so we have a Tie for Content objectData with Id 2, Id 3, Id 4 and Id 5.

The set of Content objectData candidates for application state “contact” after Applying publishgroup Precedence={Content objectData Id: 2, Content objectData Id: 3, Content objectData Id: 4, Content objectData Id: 5}.

Next, content objectversion Precedence is applied. The content objectversion of Content objectData with Id 3, Id 4 and Id 5 is higher than the content objectversion of Content objectData with Id 2. So Content objectData with Id 2 is dropped. Content objectData with Id 3, Id 4 and Id 5 have same content objectversion “v2.0” and so we have a Tie for Content objectData with Id 3, Id 4 and Id 5.

The set of Content objectData candidates for application state “contact” after Applying content objectversion Precedence={Content objectData Id: 3, Content objectData Id: 4, Content objectData Id: 5}

Next, userrole Precedence is applied. From the userrolePrecedenceList Map of the Content objectStore, illustrated in Table 2, we find that the userrole “system administrator” of Content object Data with Id 3 and Id 4 is having higher precedence compared to the userrole “contact manager” of Content object Data with Id 5. So Content objectData with Id 5 is dropped. Content objectData with Id 3 and Id 4 belongs to same userrole “system administrator” and so we have a Tie for Content objectData with Id 3 and Id 4.

The set of Content objectData candidates for application state “contact” after Applying user role Precedence is {Content objectData Id: 4, Content objectData Id: 5}.

Next, LastModifiedDate Precedence is applied. The lastmodifieddate “2016-12-24T13:43:42.248Z” of Content object Data with Id 4 is higher compared to the lastmodifieddate “2016-12-18T13:43:42.248Z” of Content object Data with Id 3. So Content objectData with Id 3 is dropped and the winner candidate is Content objectData with Id 4.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality assigned to each block. It will be noted that fewer blocks can be used so the functionality is performed by fewer components. Also, more blocks can be used with the functionality distributed among more components.

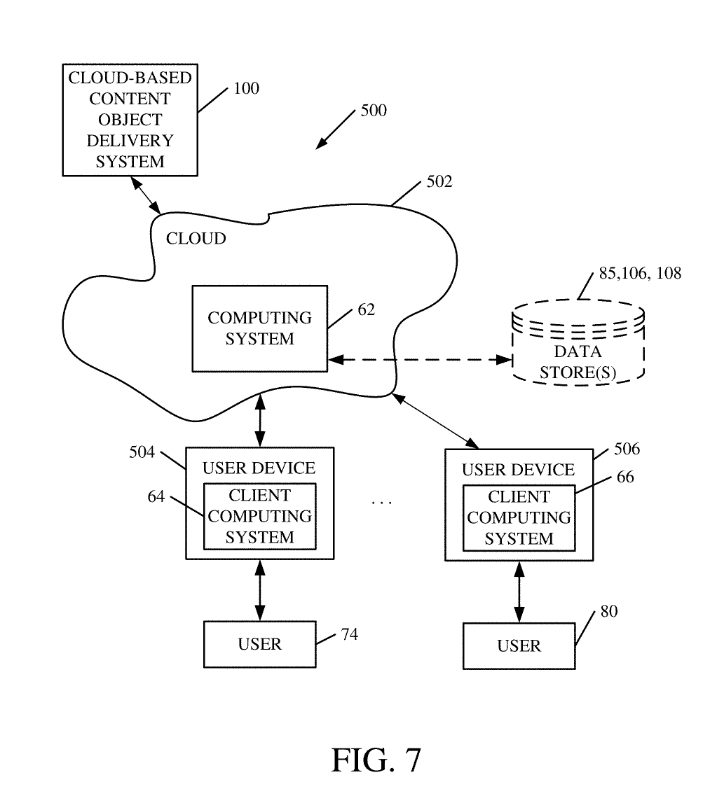

FIG. 7 is a block diagram of computing system architecture 60, shown in FIG. 1, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of system 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud can be managed by the organization itself and the infrastructure is typically not shared with other organizations. The organization still maintains the hardware to some extent, such as installations and repairs, etc.

FIG. 7 also depicts another example of a cloud architecture. In the example shown in FIG. 7, some items are similar to those shown in FIG. 1 and they are similarly numbered. FIG. 7 specifically shows that computing system 62 can be located in cloud 502 (which can be public, private, or a combination where portions are public while others are private). Therefore, users 74 and 80 use user devices 504 and 506 to access system 62 through cloud 502.

FIG. 7 shows that it is also contemplated that some elements of system 62 can be disposed in cloud 502 while others are not. By way of example, any of data store(s) 85, 106, and/or 108 can be disposed outside of cloud 502, and accessed through cloud 502. In another example, other parts of system 62 can be outside of cloud 502. Regardless of where they are located, they can be accessed directly by devices 504-506, through a network (either a wide area network or a local area network), they can be hosted at a remote site by a service, or they can be provided as a service through a cloud or accessed by a connection service that resides in the cloud. All of these architectures are contemplated herein.

It will also be noted that system 62, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

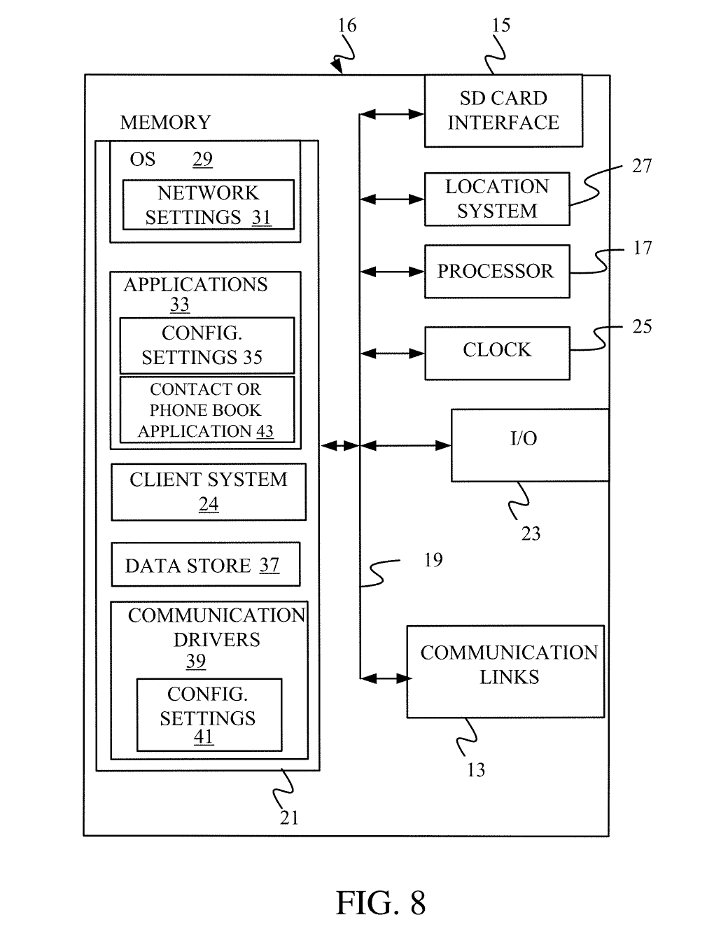

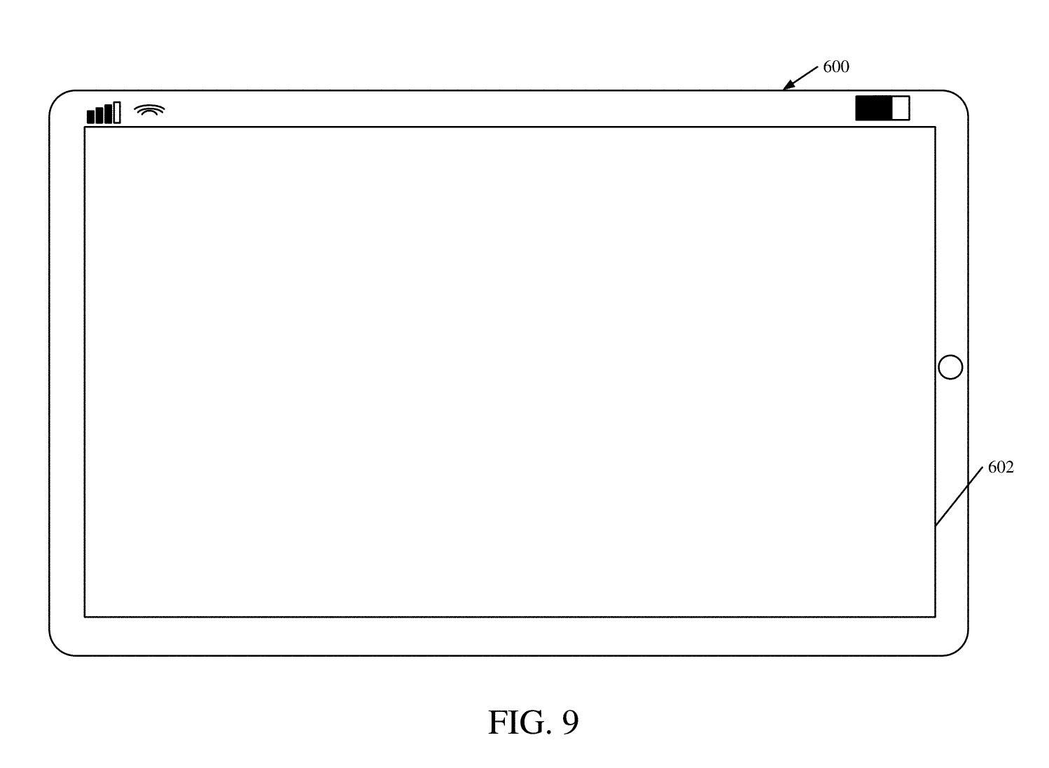

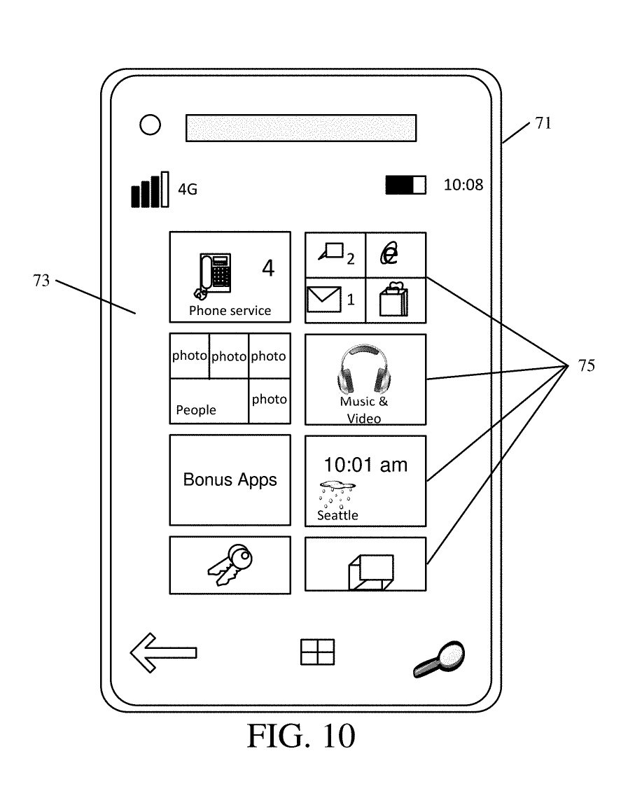

FIG. 8 is a simplified block diagram of one illustrative example of a handheld or mobile computing device that can be used as a user's or client's hand held device 16, in which the present system (or parts of it) can be deployed. FIGS. 9-10 are examples of handheld or mobile devices.

FIG. 8 provides a general block diagram of the components of a client device 16 that can run components of architecture 60 or that interacts with architecture 60, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as Wi-Fi protocols, and Bluetooth protocol, which provide local wireless connections to networks.

In other examples, applications or systems can be received on a removable Secure Digital (SD) card that is connected to a SD card interface 15. SD card interface 15 and communication links 13 communicate with a processor 17 (which can also embody processors running any of the logic illustrated or described with respect to previous FIGS.) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Similarly, device 16 can have a client system 24 which can run various applications or embody parts or all of architecture 60. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 9 shows one example in which device 16 is a tablet computer 600 with a screen 602. Screen 602 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 60 can also illustratively receive voice inputs as well.

FIG. 10 shows that the device can be a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

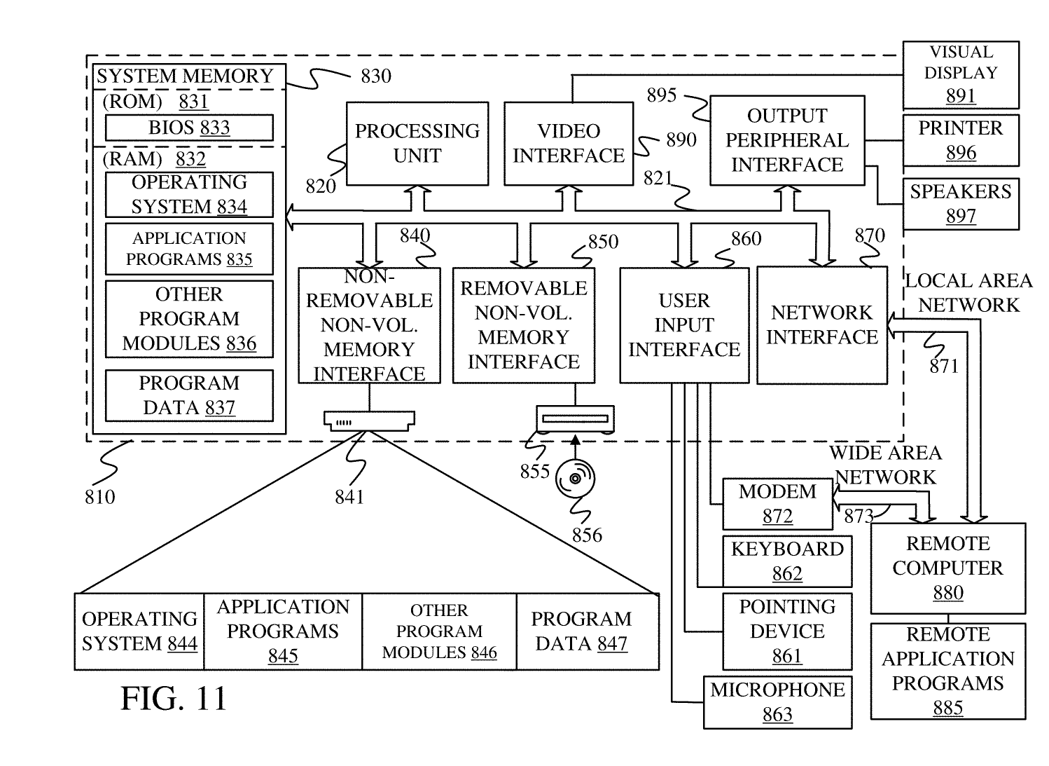

FIG. 11 is one example of a computing environment in which architecture 60 or parts of it, (for example) can be deployed. With reference to FIG. 11, an example system for implementing some embodiments includes a general-purpose computing device in the form of a computer 810. Components of computer 810 may include, but are not limited to, a processing unit 820, a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to previous FIGS. can be deployed in corresponding portions of FIG. 11.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 11 illustrates operating system 834, application programs 835, other program modules 836, and program data 837.

The computer 810 may also include other removable/non-removable volatile/nonvolatile computer storage media. By way of example only, FIG. 11 illustrates a hard disk drive 841 that reads from or writes to non-removable, nonvolatile magnetic media, and an optical disk drive 855 that reads from or writes to a removable, nonvolatile optical disk 856 such as a CD ROM or other optical media. Other removable/non-removable, volatile/nonvolatile computer storage media that can be used in the example operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 11, provide storage of computer readable instructions, data structures, program modules and other data for the computer 810. In FIG. 11, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 11 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 11 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Example 1 is a computing system, comprising:

content object selection logic that selects a content object that corresponds to an application state in an application;

state comparison logic that compares the application state corresponding to the selected content object to an application state corresponding to a stored content object that is stored in a client data store to determine whether the selected content object and the stored content object correspond to a same application state;

precedence resolution logic that, when the state comparison logic determines that the selected content object and the stored content object correspond to a same application state, identifies a higher precedence content object, of the selected content object and the stored content object, based on a precedence hierarchy of content object attributes; and

client store interaction logic that provides the higher precedence content object for storage in a client data store.

Example 2 is the computing system of any or all previous examples wherein the precedence resolution logic comprises:

precedence hierarchy retrieval logic configured to retrieve the precedence hierarchy of content object attributes, based on the application.

Example 3 is the computing system of any or all previous examples wherein each content object has a corresponding publishing group attribute, from a set of publishing group attributes, that identifies a group to which the corresponding content object is published in the application, the publishing group attributes in the set each having a corresponding precedence value.

Example 4 is the computing system of any or all previous examples wherein the precedence resolution logic further comprises:

publishing group logic that compares the publishing group attribute corresponding to the selected content object to the publishing group attribute corresponding to the stored content object to determine if either publishing group attribute has a higher corresponding precedence value and, if so, identifies, as the higher precedence content object, the content object corresponding to the publishing group attribute with the higher corresponding precedence value.

Example 5 is the computing system of any or all previous examples wherein each content object has a corresponding version attribute, from a set of version attributes, that identifies a version of the corresponding content object, wherein the precedence resolution logic further comprises:

content version logic that, if the publishing group logic determines that neither publishing group attribute has a higher corresponding precedence value, compares the version attribute corresponding to the selected content object to the version attribute corresponding to the stored content object to determine if either version attribute has a higher precedence value and, if so, identifies, as the higher precedence content object, the content object corresponding to the version attribute with the higher precedence value.

Example 6 is the computing system of any or all previous examples wherein each content object has a corresponding user role attribute, from a set of user role attributes, that identifies a role of a user that will see the corresponding content object, wherein the precedence resolution logic further comprises:

user role logic that, if the content version logic determines that neither content version attribute has a higher corresponding precedence value, compares the user role attribute corresponding to the selected content object to the user role attribute corresponding to the stored content object to determine if either user role attribute has a higher precedence value and, if so, identifies, as the higher precedence content object, the content object corresponding to the user role attribute with the higher precedence value.

Example 7 is the computing system of any or all previous examples wherein each content object has a corresponding last modified date attribute, from a set of last modified date attributes, that identifies a last modified date of the corresponding content object, wherein the precedence resolution logic further comprises:

last modified logic that, if the user role logic determines that neither user role attribute has a higher corresponding precedence value, compares the last modified date attribute corresponding to the selected content object to the last modified date attribute corresponding to the stored content object to determine if either last modified date attribute has a higher precedence value and, if so, identifies, as the higher precedence content object, the content object corresponding to the last modified date attribute with the higher precedence value.

Example 8 is the computing system of any or all previous examples and further comprising:

a content object processing system configured to obtain the content objects from an application data store and store the content objects, indexed by the content object attributes, in a service data store.

Example 9 is the computing system of any or all previous examples wherein the content object processing system comprises:

content object parsing logic configured to parse a received content object to identify values for the content object attributes of the received content object.

Example 10 is the computing system of any or all previous examples wherein the content object processing system comprises:

indexing logic configured to index the received content object based on its corresponding application state.

Example 11 is the computing system of any or all previous examples wherein the indexing logic is configured to index the received content object based on the identified values for the content object attributes of the received content object.

Example 12 is a computer implemented method, comprising:

selecting a content object that corresponds to an application state in an application;

comparing the application state corresponding to the selected content object to an application state corresponding to a stored content object that is stored in a client data store to determine whether the selected content object and the stored content object correspond to a same application state;

when the selected content object and the stored content object correspond to a same application state, identifying a higher precedence content object, of the selected content object and the stored content object, based on a precedence hierarchy of content object attributes; and

providing the higher precedence content object for storage in a client data store.

Example 13 is the computer implemented method of any or all previous examples wherein identifying a higher precedence content object comprises:

retrieving the precedence hierarchy of content object attributes, based on the application; and

comparing attribute values, corresponding to the selected content object and the stored content object, for content object attributes in the precedence hierarchy.

Example 14 is the computer implemented method of any or all previous examples wherein each content object has a corresponding publishing group attribute, from a set of publishing group attributes, that identifies a group to which the corresponding content object is published in the application, the publishing group attributes in the set each having a corresponding precedence value, wherein identifying a higher precedence content object comprises:

comparing the publishing group attribute corresponding to the selected content object to the publishing group attribute corresponding to the stored content object;

determining, based on the comparison, if either publishing group attribute has a higher corresponding precedence value; and

if so, identifying, as the higher precedence content object, the content object corresponding to the publishing group attribute with the higher corresponding precedence value.

Example 15 is the computer implemented method of any or all previous examples wherein each content object has a corresponding version attribute, from a set of version attributes, that identifies a version of the corresponding content object, wherein identifying a higher precedence content object comprises:

if neither publishing group attribute has a higher corresponding precedence value, comparing the version attribute corresponding to the selected content object to the version attribute corresponding to the stored content object to determine if either version attribute has a higher precedence value; and

if so, identifying, as the higher precedence content object, the content object corresponding to the version attribute with the higher precedence value.

Example 16 is the computer implemented method of any or all previous examples wherein each content object has a corresponding user role attribute, from a set of user role attributes, that identifies a role of a user that will see the corresponding content object, wherein identifying a higher precedence content object comprises:

if neither content version attribute has a higher corresponding precedence value, comparing the user role attribute corresponding to the selected content object to the user role attribute corresponding to the stored content object to determine if either user role attribute has a higher precedence value; and

if so, identifying, as the higher precedence content object, the content object corresponding to the user role attribute with the higher precedence value.

Example 17 is the computer implemented method of any or all previous examples wherein each content object has a corresponding last modified date attribute, from a set of last modified date attributes, that identifies a last modified date of the corresponding content object, wherein identifying a higher precedence content object comprises:

if neither user role attribute has a higher corresponding precedence value, comparing the last modified date attribute corresponding to the selected content object to the last modified date attribute corresponding to the stored content object to determine if either last modified date attribute has a higher precedence value; and

if so, identifying, as the higher precedence content object, the content object corresponding to the last modified date attribute with the higher precedence value.

Example 18 is the computer implemented method of any or all previous examples and further comprising:

prior to selecting a content object, receiving the content objects from an application data store;

parsing a received content object to identify values for the content object attributes of the received content object; and

indexing the received content object based on its corresponding application state.

Example 19 is the computer implemented method of any or all previous examples wherein indexing comprises:

indexing the received content object based on the identified values for the content object attributes of the received content object.

Example 20 is a computing system, comprising:

content object parsing logic configured to parse a received content object, received from an application data store, and to identify values for content object attributes of the received content object;

indexing logic configured to index the received content object based on a corresponding application state corresponding to an application state in the application during which the received content object is surfaced by the application, the indexing logic being further configured to index the received content object based on the identified values for the content object attributes of the received content object;

content object selection logic that selects an indexed content object that corresponds to a first application state in the application;

state comparison logic that compares the application state corresponding to the selected content object to an application state corresponding to a stored content object that is stored in a client data store to determine whether the selected content object and the stored content object correspond to a same application state;

precedence resolution logic that, when the state comparison logic determines that the selected content object and the stored content object correspond to a same application state, identifies a higher precedence content object, of the selected content object and the stored content object, based on a precedence hierarchy of content object attributes; and

client store interaction logic that provides the higher precedence content object for storage in a client data store.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computing system, comprising:
content object selection logic that selects a content object that corresponds to an application state in an application;
state comparison logic that compares the application state corresponding to the selected content object to an application state corresponding to a stored content object that is stored in a client data store to determine whether the selected content object and the stored content object correspond to a same application state;
precedence resolution logic that, when the state comparison logic determines that the selected content object and the stored content object correspond to a same application state, identifies a higher precedence content object, of the selected content object and the stored content object, based on a precedence hierarchy of content object attributes; and
client store interaction logic that provides the higher precedence content object for storage in a client data store.

2. The computing system of claim 1 wherein the precedence resolution logic comprises:
precedence hierarchy retrieval logic configured to retrieve the precedence hierarchy of content object attributes, based on the application.

3. The computing system of claim 2 wherein each content object has a corresponding publishing group attribute, from a set of publishing group attributes, that identifies a group to which the corresponding content object is published in the application, the publishing group attributes in the set each having a corresponding precedence value.

4. The computing system of claim 3 wherein the precedence resolution logic further comprises:
publishing group logic that compares the publishing group attribute corresponding to the selected content object to the publishing group attribute corresponding to the stored content object to determine if either publishing group attribute has a higher corresponding precedence value and, if so, identifies, as the higher precedence content object, the content object corresponding to the publishing group attribute with the higher corresponding precedence value.

5. The computing system of claim 4 wherein each content object has a corresponding version attribute, from a set of version attributes, that identifies a version of the corresponding content object, wherein the precedence resolution logic further comprises:
content version logic that, if the publishing group logic determines that neither publishing group attribute has a higher corresponding precedence value, compares the version attribute corresponding to the selected content object to the version attribute corresponding to the stored content object to determine if either version attribute has a higher precedence value and, if so, identifies, as the higher precedence content object, the content object corresponding to the version attribute with the higher precedence value.

6. The computing system of claim 5 wherein each content object has a corresponding user role attribute, from a set of user role attributes, that identifies a role of a user that will see the corresponding content object, wherein the precedence resolution logic further comprises:
user role logic that, if the content version logic determines that neither content version attribute has a higher corresponding precedence value, compares the user role attribute corresponding to the selected content object to the user role attribute corresponding to the stored content object to determine if either user role attribute has a higher precedence value and, if so, identifies, as the higher precedence content object, the content object corresponding to the user role attribute with the higher precedence value.

7. The computing system of claim 6 wherein each content object has a corresponding last modified date attribute, from a set of last modified date attributes, that identifies a last modified date of the corresponding content object, wherein the precedence resolution logic further comprises:
last modified logic that, if the user role logic determines that neither user role attribute has a higher corresponding precedence value, compares the last modified date attribute corresponding to the selected content object to the last modified date attribute corresponding to the stored content object to determine if either last modified date attribute has a higher precedence value and, if so, identifies, as the higher precedence content object, the content object corresponding to the last modified date attribute with the higher precedence value.

8. The computing system of claim 1 and further comprising:
a content object processing system configured to obtain the content objects from an application data store and store the content objects, indexed by the content object attributes, in a service data store.

9. The computing system of claim 8 wherein the content object processing system comprises:
content object parsing logic configured to parse a received content object to identify values for the content object attributes of the received content object.

10. The computing system of claim 9 wherein the content object processing system comprises:
indexing logic configured to index the received content object based on its corresponding application state.

11. The computing system of claim 10 wherein the indexing logic is configured to index the received content object based on the identified values for the content object attributes of the received content object.

12. A computer implemented method, comprising:
selecting a content object that corresponds to an application state in an application;
comparing the application state corresponding to the selected content object to an application state corresponding to a stored content object that is stored in a client data store to determine whether the selected content object and the stored content object correspond to a same application state;
when the selected content object and the stored content object correspond to a same application state, identifying a higher precedence content object, of the selected content object and the stored content object, based on a precedence hierarchy of content object attributes; and
providing the higher precedence content object for storage in a client data store.

13. The computer implemented method of claim 12 wherein identifying a higher precedence content object comprises:
retrieving the precedence hierarchy of content object attributes, based on the application; and
comparing attribute values, corresponding to the selected content object and the stored content object, for content object attributes in the precedence hierarchy.

14. The computer implemented method of claim 13 wherein each content object has a corresponding publishing group attribute, from a set of publishing group attributes, that identifies a group to which the corresponding content object is published in the application, the publishing group attributes in the set each having a corresponding precedence value, wherein identifying a higher precedence content object comprises:
comparing the publishing group attribute corresponding to the selected content object to the publishing group attribute corresponding to the stored content object;
determining, based on the comparison, if either publishing group attribute has a higher corresponding precedence value; and
if so, identifying, as the higher precedence content object, the content object corresponding to the publishing group attribute with the higher corresponding precedence value.

15. The computer implemented method of claim 14 wherein each content object has a corresponding version attribute, from a set of version attributes, that identifies a version of the corresponding content object, wherein identifying a higher precedence content object comprises:
if neither publishing group attribute has a higher corresponding precedence value, comparing the version attribute corresponding to the selected content object to the version attribute corresponding to the stored content object to determine if either version attribute has a higher precedence value; and
if so, identifying, as the higher precedence content object, the content object corresponding to the version attribute with the higher precedence value.

16. The computer implemented method of claim 15 wherein each content object has a corresponding user role attribute, from a set of user role attributes, that identifies a role of a user that will see the corresponding content object, wherein identifying a higher precedence content object comprises:
if neither content version attribute has a higher corresponding precedence value, comparing the user role attribute corresponding to the selected content object to the user role attribute corresponding to the stored content object to determine if either user role attribute has a higher precedence value; and
if so, identifying, as the higher precedence content object, the content object corresponding to the user role attribute with the higher precedence value.

17. The computer implemented method of claim 16 wherein each content object has a corresponding last modified date attribute, from a set of last modified date attributes, that identifies a last modified date of the corresponding content object, wherein identifying a higher precedence content object comprises:
if neither user role attribute has a higher corresponding precedence value, comparing the last modified date attribute corresponding to the selected content object to the last modified date attribute corresponding to the stored content object to determine if either last modified date attribute has a higher precedence value; and
if so, identifying, as the higher precedence content object, the content object corresponding to the last modified date attribute with the higher precedence value.

18. The computer implemented method of claim 12 and further comprising:
prior to selecting a content object, receiving the content objects from an application data store;
parsing a received content object to identify values for the content object attributes of the received content object; and
indexing the received content object based on its corresponding application state.

19. The computer implemented method of claim 18 wherein indexing comprises:
indexing the received content object based on the identified values for the content object attributes of the received content object.

20. A computing system, comprising:
content object parsing logic configured to parse a received content object, received from an application data store, and to identify values for content object attributes of the received content object;
indexing logic configured to index the received content object based on a corresponding application state corresponding to an application state in the application during which the received content object is surfaced by the application, the indexing logic being further configured to index the received content object based on the identified values for the content object attributes of the received content object;
content object selection logic that selects an indexed content object that corresponds to a first application state in the application;
state comparison logic that compares the application state corresponding to the selected content object to an application state corresponding to a stored content object that is stored in a client data store to determine whether the selected content object and the stored content object correspond to a same application state;
precedence resolution logic that, when the state comparison logic determines that the selected content object and the stored content object correspond to a same application state, identifies a higher precedence content object, of the selected content object and the stored content object, based on a precedence hierarchy of content object attributes; and
client store interaction logic that provides the higher precedence content object for storage in a client data store.
